(19) United States
(12) Patent Application Publication
(10) Pub. No.: US 2026/0243378 A1
(43) Pub. Date: Aug. 20, 2026

(54) PIPELINER BLADDER ASSEMBLY

(71) Applicant: American Pipelining Solutions LLC, Anderson, SC (US)

(72) Inventors: Jacob SALTZMAN, Anderson, SC (US); John Taylor MARTIN, Hartwell, GA (US); Christopher DEAN, Anderson, SC (US)

(73) Assignee: American Pipelining Solutions LLC, Anderson, SC (US)

(21) Appl. No.: 19/537,044

(22) Filed: Feb. 11, 2026

Related U.S. Application Data
(63) Continuation-in-part of application No. 19/055,245, filed on Feb. 17, 2025.

(51) Int. Cl. F16L 55/134; F16L 55/163; F16L 55/165; F16L 55/17; F21Y 115/10

(52) U.S. Cl. CPC F16L 55/134; F16L 55/163; F16L 55/165; F16L 55/1651; F16L 55/1653; F16L 55/1654; F16L 55/17; F21Y 2115/10

(57) ABSTRACT

A pipeliner bladder assembly uses a string of LED radiation sources to cure a bladder impregnated with a radiation-curable resin. A pulse width modulator delivers pulsed DC power to the LED string. The LED string may be spirally wound on a light carrier, which may be a braided hose. The bladder is strong enough that it may be used to pull the entire assembly into the pipe and to the location of repair, without using a separate pull strap. The bladder may withstand high internal inflation pressures for better conformance. The light carrier and LED string are not stressed with tensile or compressive forces while being moved into position within the pipe.

### RELATED APPLICATIONS

This application is a continuation in part of copending U.S. patent application Ser. No. 19/055,245 filed Feb. 17, 2025, the disclosure of which is fully incorporated herein by reference.

### BACKGROUND OF THE INVENTION

The field of the invention relates to the trenchless repair of pipes. More particularly, the invention relates to pipeliner bladder assemblies used to line preexisting pipes.

Bladder assemblies for the repair of pipes are known. In several prior art examples, the bladder assemblies have a stretchable bladder, and, exterior to the bladder, a layer of resin-impregnated felt. The resin is often curable by ultraviolet light. For this reason, an ultraviolet light source is either incorporated into the bladder wall or provided in a carrier disposed inside of the bladder. Such light sources may be string(s) of LEDs. Other bladder assemblies use infrared light sources and an epoxy resin in the liner to be cured. The bladder itself typically is made of an elastomer, typically silicone rubber, and stretches in all directions when inflated. Prior art bladder assemblies typically will also include a pull strap by which the assembly is pulled into place in the pipe. The other structures in these prior art pipeliner bladder assemblies are insufficient to accept, without failure, the considerable tensile force required to move the pipeliner assembly into place inside the pipe.

### SUMMARY OF THE INVENTION

According to one aspect of the invention, a pipeliner bladder assembly comprises an elongate carrier mounting a radiation source, such as ultraviolet or infrared. Disposed radially exteriorly to the carrier is a flexible, fluid-impervious bladder made of a material that is dimensionally stable. Disposed radially exteriorly to the bladder is a liner that is impregnated with a radiation-curable resin. The bladder may be used to pull the entire assembly into place inside the pipe, as it is strong enough to accept the tensile force required.

In operation, the assembly is pulled into the pipe to be repaired, with at least some or most of the axial tension being borne by the bladder. No separate pull strap is necessary. The bladder is then inflated to press the impregnated liner against the pipe wall. The radiation source is then switched on to cure the resin. After curing, the bladder is deflated and the bladder and carrier are withdrawn from the pipe.

According to another aspect of the invention, a pipeliner bladder assembly comprises an elongate light carrier formed on an axis. The light carrier or light bar has axially spaced apart proximal and distal ends and at least a first lumen extending from the proximal end to the distal end. At least one LED light string is helically wound on the external surface of the light carrier. A bladder is disposed radially exteriorly of the light string and has proximal and distal ends. A liner is disposed radially exteriorly of the bladder and is impregnated with a resin curable by radiation from the LED light string. A flexible push or reinforcement rod is loosely inserted from the proximal end of the light carrier to the distal end thereof. An air head of the assembly is disposed axially proximally from the proximal end of the light carrier but is not directly connected to it. The air head has an axially aligned surface to which the proximal end of the bladder is sealed. Ports in the air head communicate to an interior of the bladder to inflate and deflate it. A pull head is disposed axially distally from the distal end of the light carrier but is not directly connected to it. The pull head has an axially aligned surface to which the distal end of the bladder is sealed. A pull eye is attached to a distal end of the pull head. The air head has a push rod receptable in its distal end and the pull head has a push rod receptacle in its proximal end. The proximal end of the push rod is affixed to the air head push rod receptacle while the distal end of the push rod is affixed to the pull head push rod receptacle. In this way, the light carrier, LED light string and associated conductors and probe(s) will not be subjected to tensile and compressive stresses experienced by the bladder assembly as it is being moved into position inside the pipe to be repaired.

According to a further aspect of the invention, a pipeliner bladder assembly has an elongate light carrier or light bar disposed on an axis. A fluid-impervious bladder is disposed radially exteriorly of the light carrier, the bladder being radially inflatable upon the application of a pressurized gas internal to the bladder. A liner is disposed radially exteriorly of the bladder, and is impregnated with a light-curable resin. The light carrier has an exterior surface, on which is mounted at least one temperature probe. A plurality of temperature probe conductors extend from a proximal end of the light carrier and are coupled to the temperature probe to transmit a temperature signal from the probe.

According to a still further aspect of the invention, a system for the trenchless repair of a pipe includes a pipeliner bladder assembly disposed on an axis and adaptable to be pulled or pushed into a pipe to be repaired. The assembly includes an elongate light carrier or light bar disposed on the axis and has an external surface radially displaced from the axis. A plurality of resin-curing radiation sources are mounted on the external surface of the light carrier. The light carrier is hollow, and has opposed proximal and distal axial ends. At least one lumen communicates the proximal end to the distal end. An air head is disposed on the axis at the proximal end of the light carrier and has at least one air port. An elongate gas-impervious bladder is disposed radially around the light carrier. A proximal end of the bladder is sealably affixed to the air head. The air port of the air head is in fluid communication with an interior of the bladder. An elongate liner is disposed radially exteriorly of the bladder and is impregnated with a radiation-curable resin. A controller has a plurality of output power conductors. A power switch of the controller selectably connects or disconnects at least one of the output power conductors to a source of electrical power. A pressurized air source of the controller is connected to a first end of a pressurized air conduit, the controller being operable to regulate the air pressure inside of the air conduit. The output power conductors are disposed in an interior of the air conduit. A second end of the air conduit is coupled to an inlet of the air head. A chamber of the air head connects the inlet of the air head to the at least one air port. The output power conductors terminate in a connector disposed in the chamber. Second power conductors have first ends connected to the connector. Second ends of the second power conductors are routed through the at least one air port of the air head to the at least one lumen of the carrier and are coupled to the resin-curing radiation sources to supply power thereto. Pressurized air is supplied through the at least one air port of the air head to inflate the bladder prior to cure.

In one embodiment, the pressurized air conduit has one section leading from the controller to a chassis mounting a cable reel, and a second section which is unwound from the cable reel and is connected directly or indirectly to the air head inlet. LED power and temperature probe conductors are provided by a first line from the controller or control box to a hermetically sealed hub of the cable reel by. The conductors in the first line are connected to inputs on a stator side of multiple-conductor slip ring enclosed in the hub. Corresponding conductors are connected to outputs on a rotor side of the slip ring unit and then routed into a second section of the air conduit. The slip rings permit the conductor-containing second section of the air conduit to be wound and unwound at need.

The present invention avoids the incorporation of a separate pull strap, simplifying and lowering the cost of the assembly and aiding in its manipulation inside the pipe, and provides a more robust pipeliner assembly that better accepts tensile and compressive stresses placed on the assembly during movement inside the pipe. The present invention provides a pipeliner bladder assembly capable of being inflated to much higher pressures, such as 50-60 psi, better conforming to the pipe to be repaired.

### BRIEF DESCRIPTION OF THE DRAWINGS

Further aspects of the invention and their advantages can be discerned in the following detailed description as read in conjunction with the drawings of exemplary embodiments, in which like characters denote like parts and in which:

FIG. 1 is a schematic diagram of a trenchless pipe repair system, including a control box, an air reel chassis and an assembled packer, shown installed in a pipe but prior to inflation;

FIG. 1A is a detail of the face of the control box shown in FIG. 1;

FIG. 1A-1 is a magnified detail of a pressure gauge of the control box;

FIG. 1B is a schematic electrical diagram of the control box;

FIG. 2 is a schematic axial sectional view of an air head and beginning length of a connected packer assembly, prior to insertion into a pipe to be repaired;

FIG. 3 is a schematic axial sectional view of a pull head and ending length of a packer assembly terminated by the pull head, prior to insertion into a pipe to be repaired;

FIG. 4 is a schematic cross-sectional view of a packer assembly at about the middle of its length, prior to its insertion into a pipe to be repaired;

FIG. 5 is a schematic axial sectional view of an air head and connected portions of the packer assembly shown in FIG. 1, but shown after being pulled through a pipe to a repair location, and after a bladder thereof has been inflated;

FIG. 6 is a schematic axial sectional view of a pull head and connected portions of the packer assembly shown in FIG. 2, but shown after being pulled through a pipe to a repair location, and after a bladder of the assembly has been inflated;

FIG. 7 is a schematic cross-sectional view of a packer assembly at about the middle of its length, after the packer assembly has been pulled to a repair location in a pipe and after a bladder thereof has been inflated;

FIG. 8A is a front perspective view of an air head for use with the invention;

FIG. 8B is a rear perspective view of the air head shown in FIG. 8A;

FIG. 9A is a side perspective view of a pull head as connected to an end of a light carrier;

FIG. 9B is a side perspective view of a pull head with a pull eye removed, showing also a replacement sphere for use in a packer pushing operation;

FIG. 10 is a perspective detail of a pull head as a component of a completed bladder assembly, showing the use of a pulling link;

FIG. 11 is an end-on perspective view of a light carrier and reinforcing fiberglass central rod, for use in a bladder assembly according to the invention;

FIG. 12 is a perspective detail of a light carrier as supporting a helix of LED lights used as a curing light source in the invention;

FIG. 13 is a perspective detail showing alternative routing of conductors for the light carrier;

FIG. 14 is a perspective detail showing an air hose and wiring prior to their connection to an air head;

FIG. 15 is a perspective detail showing the use of a terminal section of an air hose;

FIG. 16 is a perspective detail showing a stage in the assembly of the pipeliner bladder assembly, particularly showing a bladder pull rope;

FIG. 17 is a schematic diagram of the electrical and certain pneumatic elements of a trenchless pipeline repair system according to the invention;

FIG. 18 is a perspective detail of a stator side of a cable/hose reel according to the invention;

FIG. 19 is a perspective detail of a rotor side of the cable/hose reel shown in FIG. 18;

FIG. 20 is an enlarged detail of FIG. 19, showing an output gland and hose;

FIG. 21 is a detail of the rotor side of the cable/hose reel, showing a hermetic connection box;

FIG. 22 is a schematic electrical diagram of an embodiment of the invention employing a pulse width modulator; and

FIG. 23 is a schematic cross sectional view of an embodiment employing an alternative light carrier.

### DETAILED DESCRIPTION

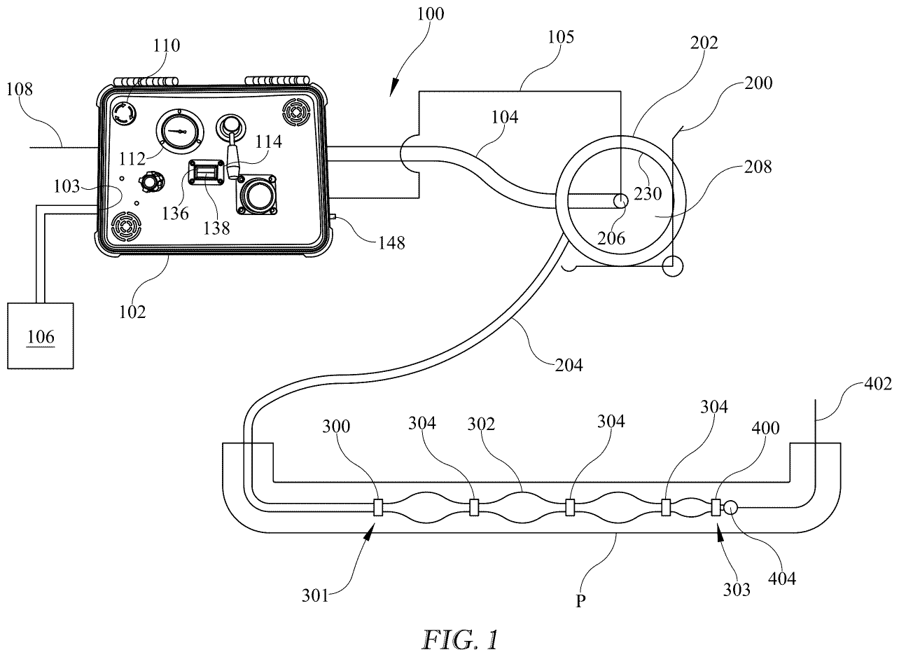

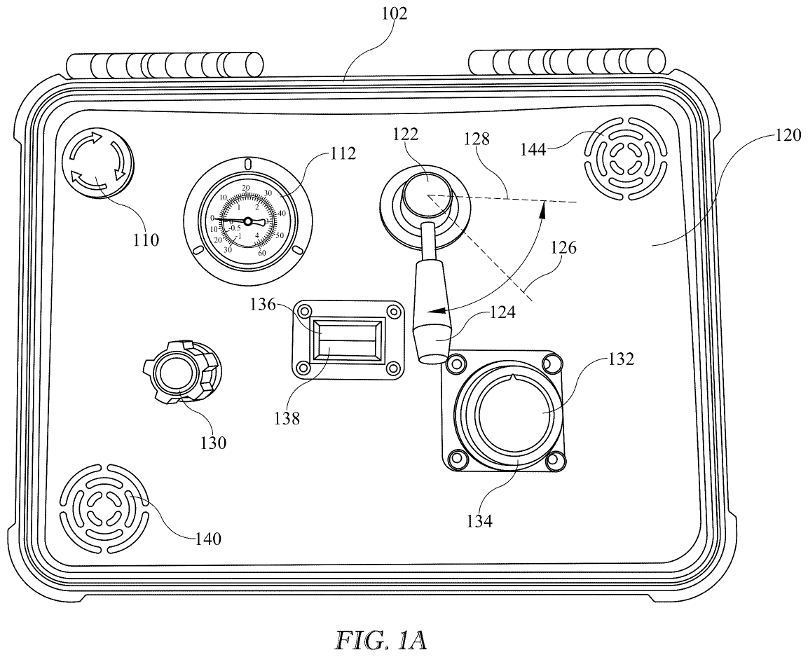

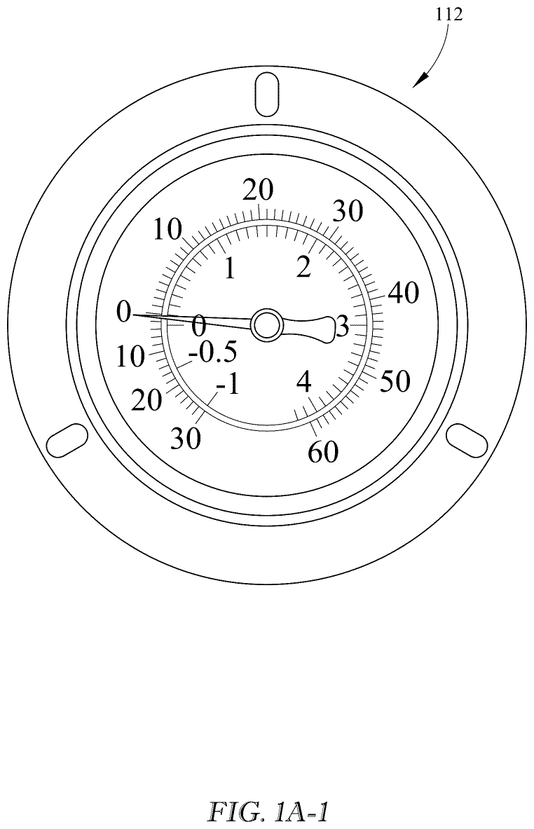

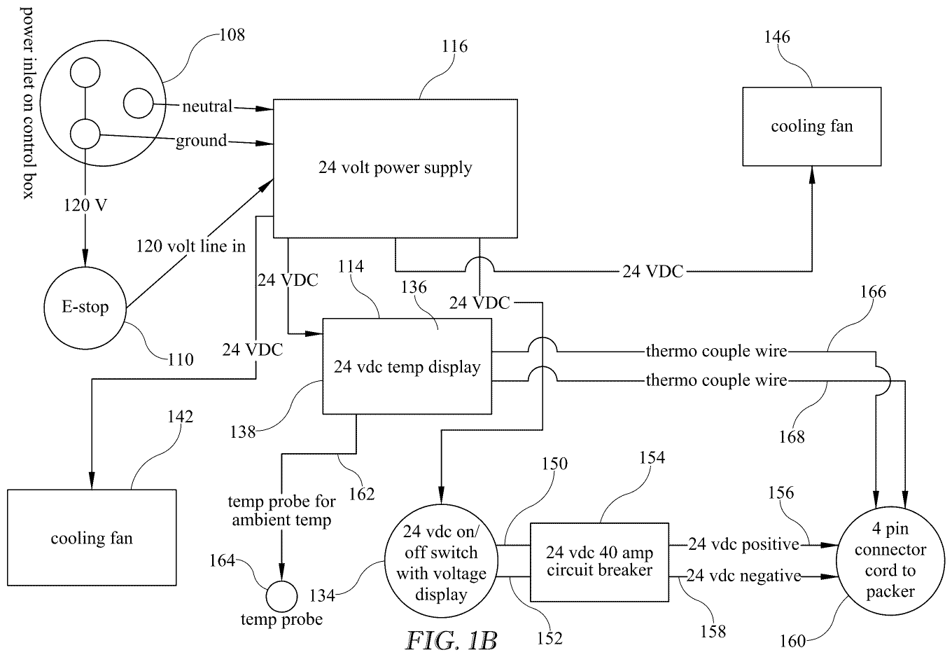

FIG. 1 is a schematic diagram of the major components of the invention. A system indicated generally at 100 includes a control box 102, an output air/vacuum hose 104, a four-conductor electrical line 105, chassis 200 including a cable/hose reel 202, a conductor-containing hose 204 connecting the reel 202 to an air head 300 disposed at a proximal end 301 of a completed pipeliner bladder assembly or packer 302, a pull head 400 connected to an opposed distal end 303 of the pipeliner bladder assembly 302, and a pull rope 402 affixed directly or indirectly to a pull eye 404 of the pull head 400.

The pipeliner bladder assembly 302 is shown installed in a pipe P that requires repair. The pipe P may be of various sizes, such as pipes having two, four, six, eight and twelve inch internal diameters, and may be made of PVC or other materials. One size of the pipeliner assembly 302 could be dimensioned to fit into two and four and inch pipes, while another size of the pipeliner assembly 302 could be dimensioned for use in six and eight inch pipes. Other pipe sizes may be accommodated by varying some of the dimensions of the light carrier, bladder, air head, pull head and impregnated liner, all of which will be described below.

In its condition as shown in FIG. 1, the pipeliner assembly 302 is not yet inflated and the bladder 328 thereof is slack. Rubber bands 304, or alternatively other ligatures which will break upon inflation of the bladder 328 (described in detail below) beyond a predetermined internal pressure, are placed at convenient places along the pipeliner assembly 302 for ease in pulling the pipeliner assembly 302 through the pipe P until the desired repair location is reached.

The bladder 328 making up a portion of the assembly 302 may come in several predetermined lengths, one of which is chosen by the user according to the length of pipe P that needs to be repaired. For example, pipeliner assemblies 302 may be made available in 3 foot, 10 foot and 30 foot lengths. Additionally, the pipeliner assemblies 302, and the bladder 328 constituting a part of them, may be fabricated to custom lengths for particular applications, or to other predetermined lengths. The bladder 328 may also come in several diameters as completely inflated, so as to be correctly sized for the pipe P that the assembly is to repair.

The control box 102 accepts a compressed air inlet 103 from an air compressor 106. The air compressor 106 provides air or other compressed gas to the control box 102, which may selectably valve such compressed gas to air hose 104 and which may regulate the pressure of the delivered gas. A power input 108, such as 110V AC or optionally or also 220V AC, supplies power to the control box 102, each of its internal components and also is the ultimate source of the DC power fed to conductors that run inside electrical line 105. Control box 102 has internal circuitry (see FIG. 1B) that includes an AC to DC power supply 116. The control box 102 may have a start switch 110 which also acts as an emergency stop to cut off all operation of the control box and downstream components. A pressure display 112 shows the air pressure at the output of hose 104, and the internal pressure inside of the connected downstream bladder 328 will be a large fraction of this. A digital display 114 may report the temperature of a bladder assembly temperature probe 368, to be later described. In one embodiment the control box 102 may also have suitable controls to set the time of illumination by the LED light string that causes the curing of the pipeliner being used. A venturi port 148 may be used to introduce a source of partial vacuum to control box 102 and this source of partial vacuum may be selectively communicated to output hose 104.

One embodiment of a face 120 of control box 102 is shown in more detail in FIG. 1A. Switch 110 may be rotated to turn the power to the control box 102 on and off, but also acts as an emergency stop switch which will be actuated by downward pressure. The pressure gauge 112 reads both positive pressure and partial vacuum, in bar, as applied to the hose 104. A long-handled selector valve 122 may be swung to any of three positions: a vacuum position 124 during which the valve 122 will connect a vacuum source to the supply hose 104; a hold position 126 whereat the valve 122 will not induce any change in internal pressure of the hose 104 or bladder 328; and a pressure position 128 at which the valve 122 will connect the hose 104 to pressurized air or other gas. An air pressure regulator knob 130 may be twisted to change the pressure of the air being delivered to hose 104.

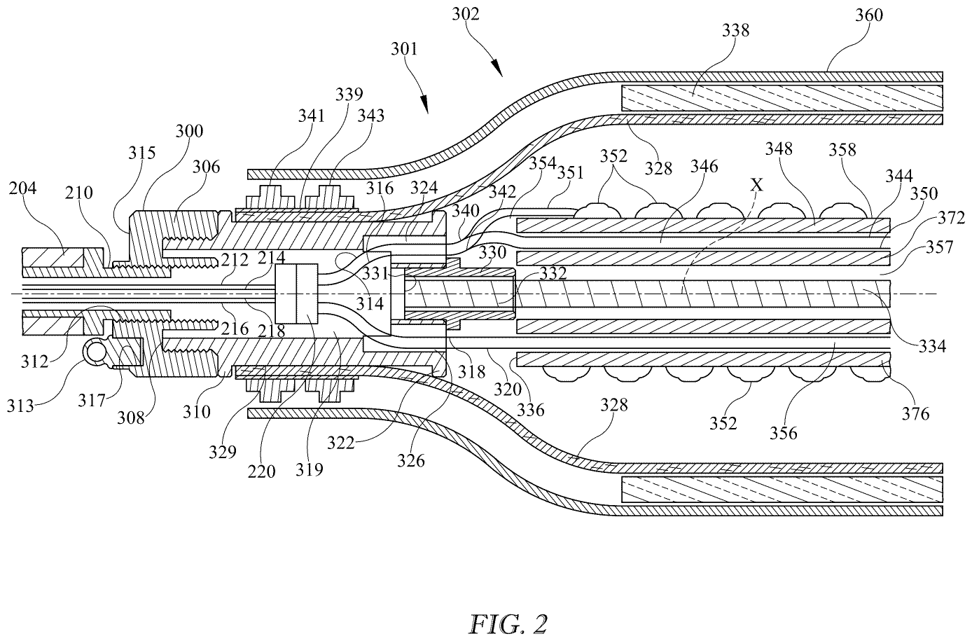

The voltage being supplied to an LED light string 352 (see, e.g., FIGS. 2, 12 and 17) appears on a face 132 of a voltage regulator dial 134. The dial may be twisted from a fully off position, during which no power is being supplied to the LEDs, to a fully on position in which maximum voltage is being so supplied. In embodiments, maximum output voltage is 24V DC or 27V DC, and the user may finely adjust how much of this maximum voltage is applied to the light string 352, and therefore how much radiance is being emitted by it.

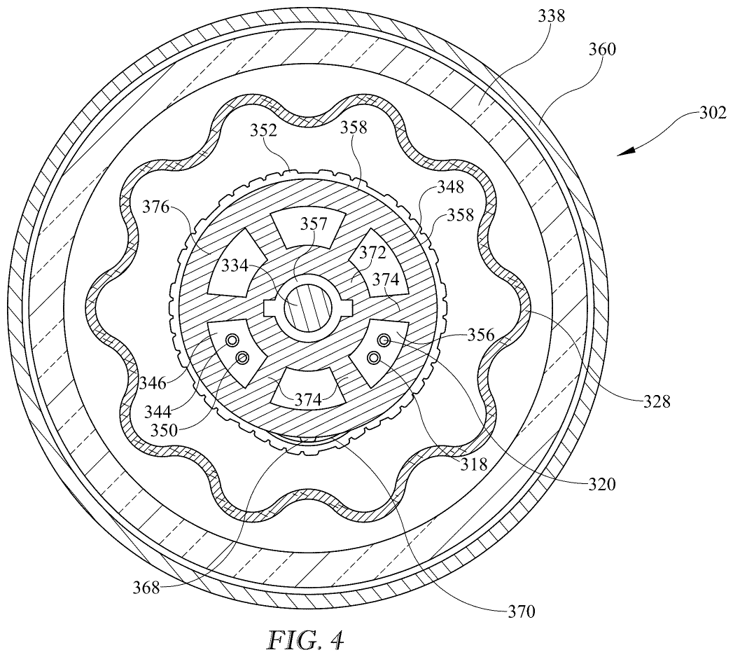

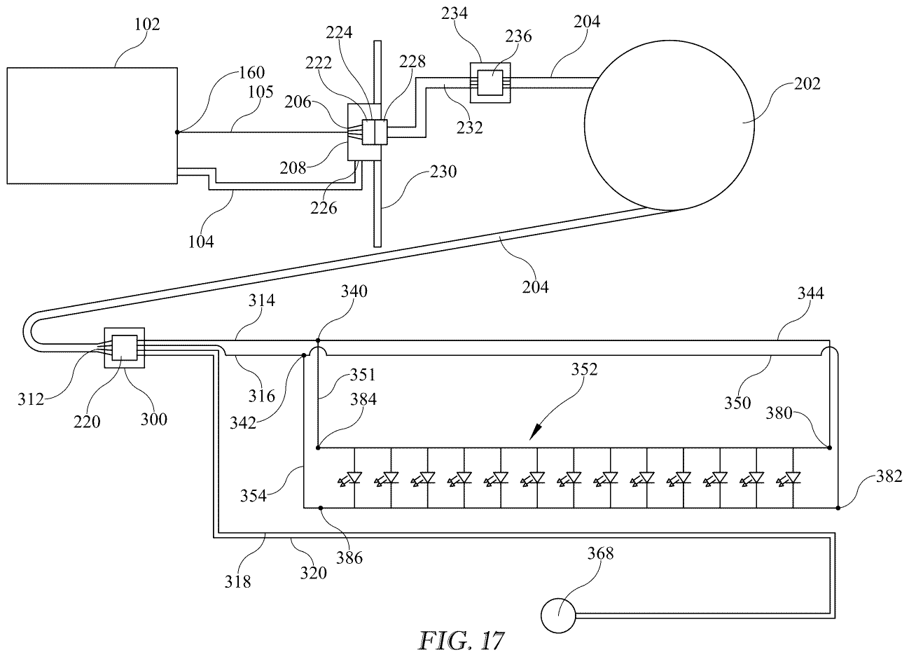

Face 120 further has a first digital readout 136 that displays the temperature detected by a probe inside of the box 102, and a second digital readout 138 that displays the temperature detected by a bladder assembly temperature probe 368 (see FIGS. 4 and 17). A lower left vent 140 is for an input fan 142, while an upper right vent 144 is for an output fan 146, creating a cooling air flow through of the control box 102.

In an alternative embodiment, the light box 102 could also include a digital timer for use in determining how long the curing by radiation should continue.

A wiring diagram for control box 102 is shown in FIG. 1B. Power from inlet 108 is interruptible by switch 110. 110V AC power is converted to 24V DC or 27V DC power by power supply 116, which in turn supplies DC power to fans 142 and 146, temperature displays 136 and 138, and voltage on/off switch and display 134. Positive and negative DC voltage lines 150 and 152 connect switch 134 to a circuit breaker 154. A positive line 156 and a negative or return line 158 connect the circuit breaker 154 to two pins of a 4-pin connector 160 for the output electrical line 105.

A line 162 connects an input of temperature display 136 to an internal temperature probe 164, used to detect the temperature inside of the control box 102. Thermocouple lines 166 and 168 are connected to inputs of temperature display 138 and terminate in the other two pins of the connector 160.

Referring back to FIG. 1, output hose 104 is connected directly or indirectly to a side port of a hermetically sealed hub 208. Conductor line 105 is connected to a central port 206 of the hub 208. The electrical conductors inside of line 105 are coupled to corresponding conductors in power/air output hose 204, while air or vacuum from air hose 104 is communicated to an interior of the power/air hose 204. The hose 204 may for example be 85 feet long and in an unused condition may be wound on hose reel 202, which rotates on a rotor component 230 associated with the hub or stator 208. The chassis 200 may be wheeled and may also accommodate storage for the bladder assembly to be used on the job, or to store other bladder assemblies.

FIG. 17 is a schematic electrical diagram of the pipeline repair system external to control box 102. From connector 160, the four-conductor line 105 is connected to a stator side 222 of a 4-conductor slip ring unit 224, which may for example be a MW 1410 made by Moflon. Slip ring unit 224 is contained inside of hub 208 and the connection of line 105 to central port 206 thereof is sealed. Air or vacuum is communicated to hub 208 through a side port 226. The slip ring unit 224 has a rotor side 228 that rotates with a rotor component 230 of the cable reel 202.

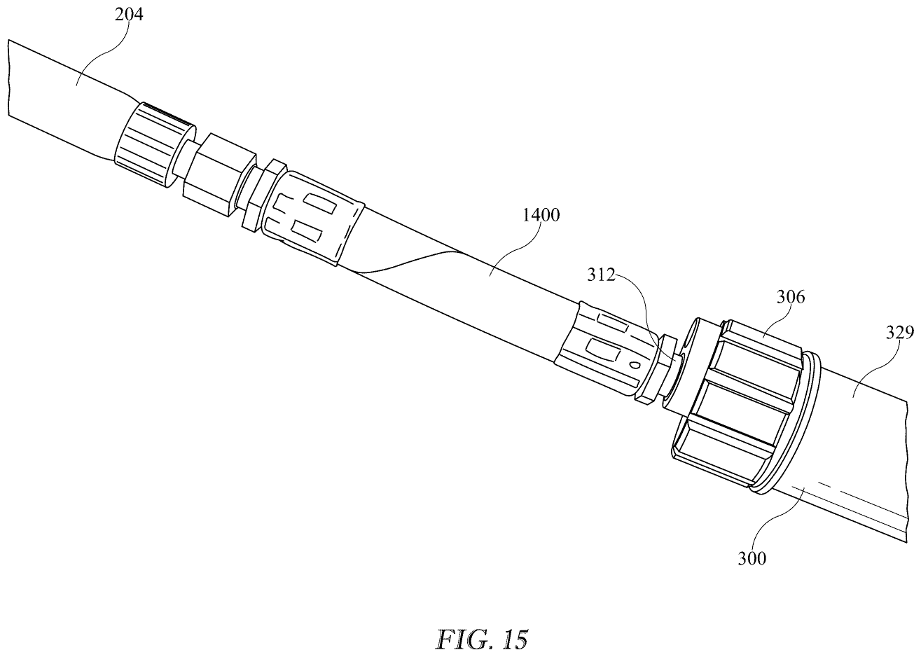

A 4 conductor-containing hose 232 runs from the sealed hub 208 to a hermetically sealed connection box 234, in which is a connector 236 that accepts the four conductors threaded through line 232 and outputs four conductors to output hose 204, which is wound on reel 202. The distal end of hose 204 (as including a terminal hose section 1400, see FIG. 15) is connected to central input port 312 of air head 300. A connector 220 housed inside of a chamber in air head 300 terminates the conductors in hose 204 and respectively connects them to a positive LED power conductor 314, a return LED conductor 316, a temperature probe power conductor 318, and a temperature probe return conductor 320.

LED power conductor 314 branches at node 340 to an internal LED power conductor 344 that in turn is connected to a distal power terminal 380 of the LED light string 352. LED return conductor 316 branches at node 342 to an internal LED return conductor 350 that is connected to a distal return terminal 382 of the LED light string 352. The other branch 351 of the LED power conductor is connected to a proximal terminal 384 of the LED light string 352, while the other branch 354 of the LED return conductor is connected to a proximal terminal 386 of the LED light string 352. The LED light string 352 is connected at both of its ends to better distribute power to its many parallel-connected LEDs and mitigate problems associated with voltage drop and line loss along the possibly long length of light string 352. Further, the branches offer alternative routes for the supply of power in the case that one of those branches is damaged.

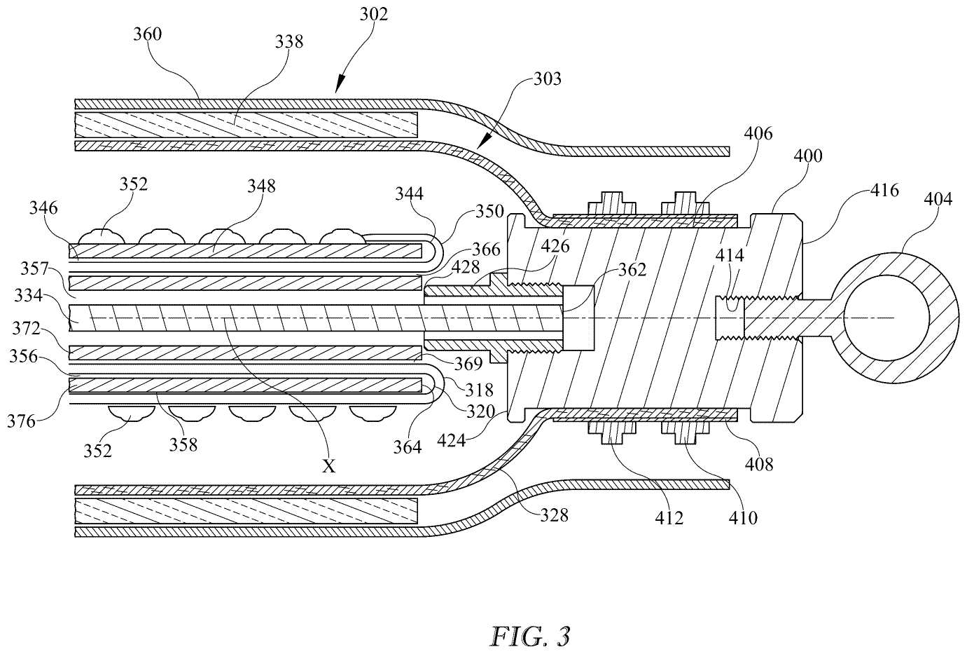

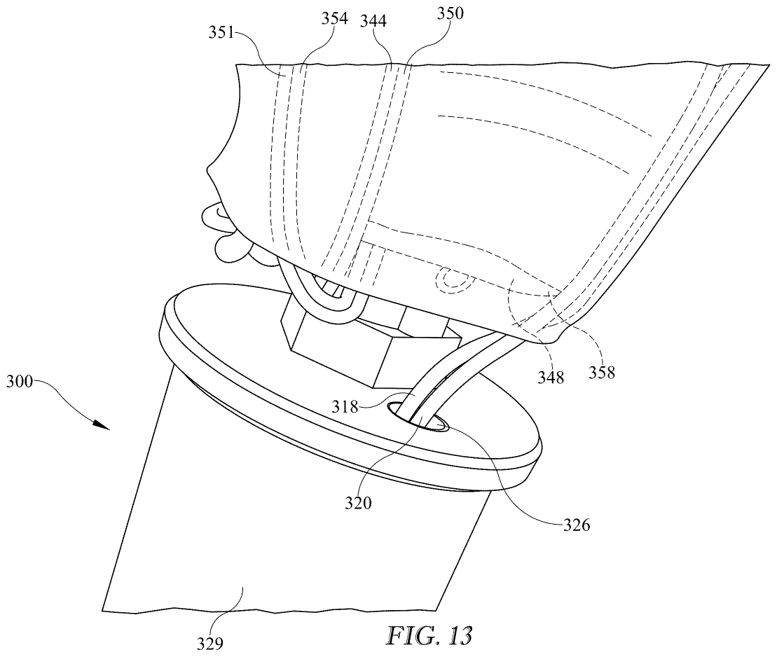

The temperature probe or thermocouple conductors 318 and 320 are either routed internally down the entire length of the light carrier 348 (see FIG. 2) and then brought back on its surface 358 to temperature probe 368 (FIGS. 3 and 4), or, in another embodiment (see FIG. 13), are simply routed on the external surface 358 of the light carrier 348 and then connected to temperature probe 368.

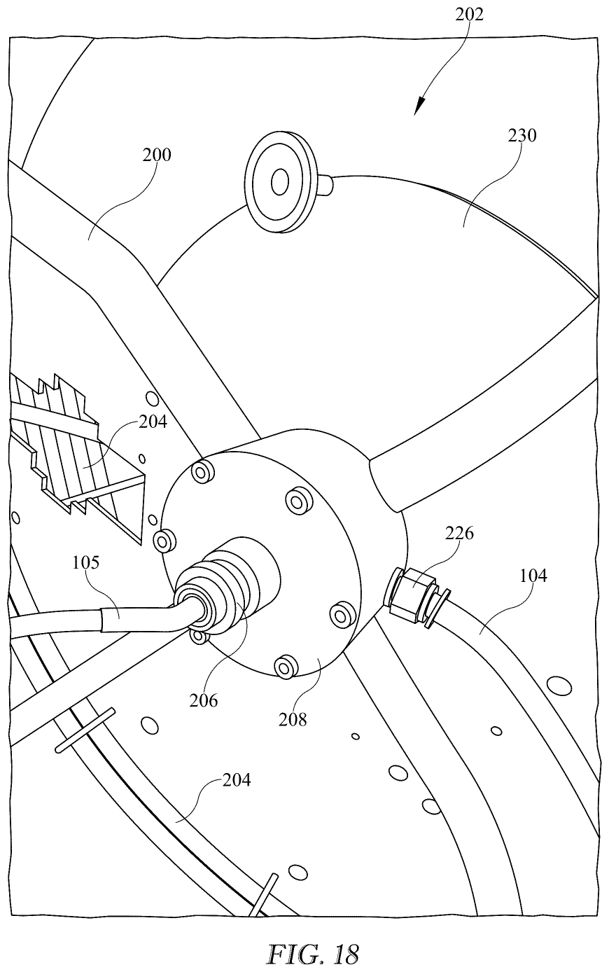

FIG. 18-21 provide some details of the structure of cable/hose reel 202. In FIG. 18, showing the stator side of the reel 202, the electrical line 105 is shown connected to a central or axial port 206 of the hub 208, while the air/vacuum hose 104 is connected by a suitable fitting to a side port 236 of the hub 208. The chassis 200 physically supports hub 208. The four-conductor slip ring unit 224 (FIG. 17) is mounted inside hub 208. The rotor component 228 of slip ring unit 224 rotates with the rotor component 230 of the cable reel 202.

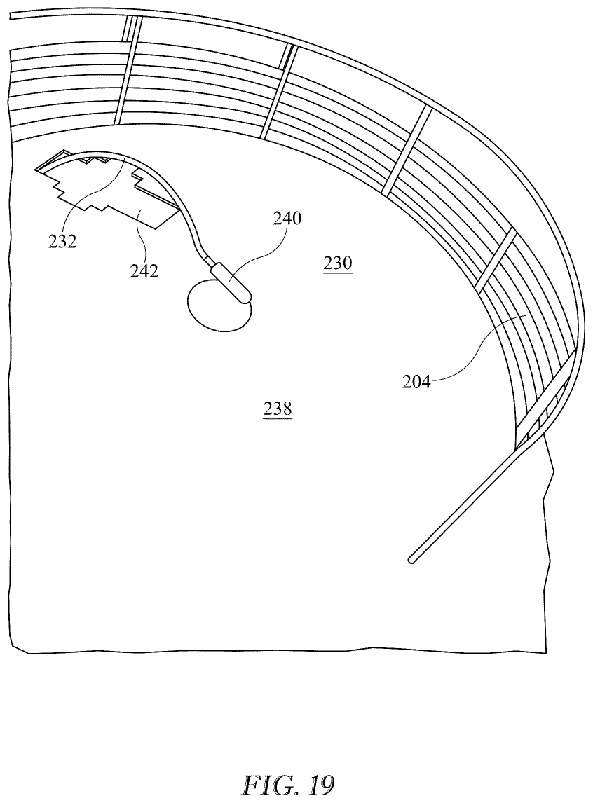

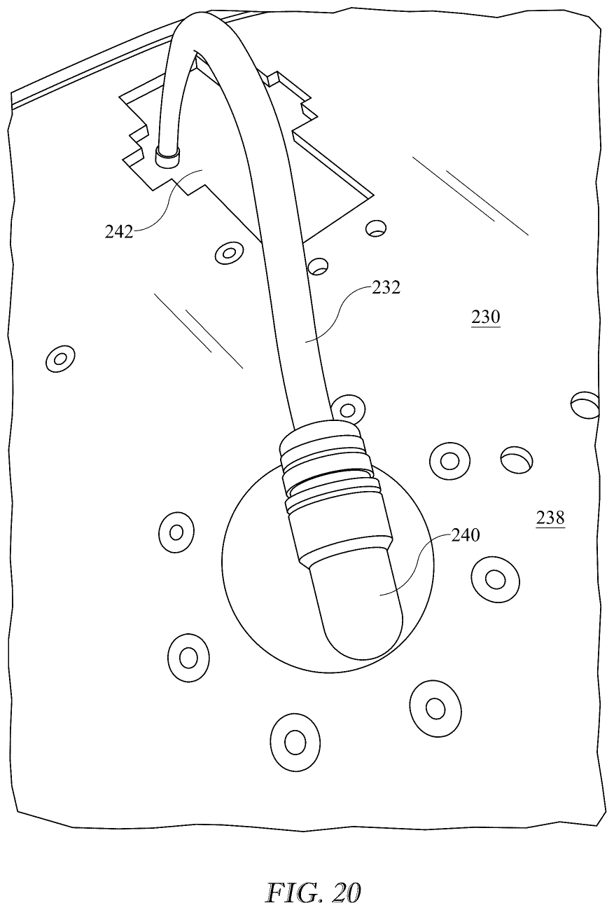

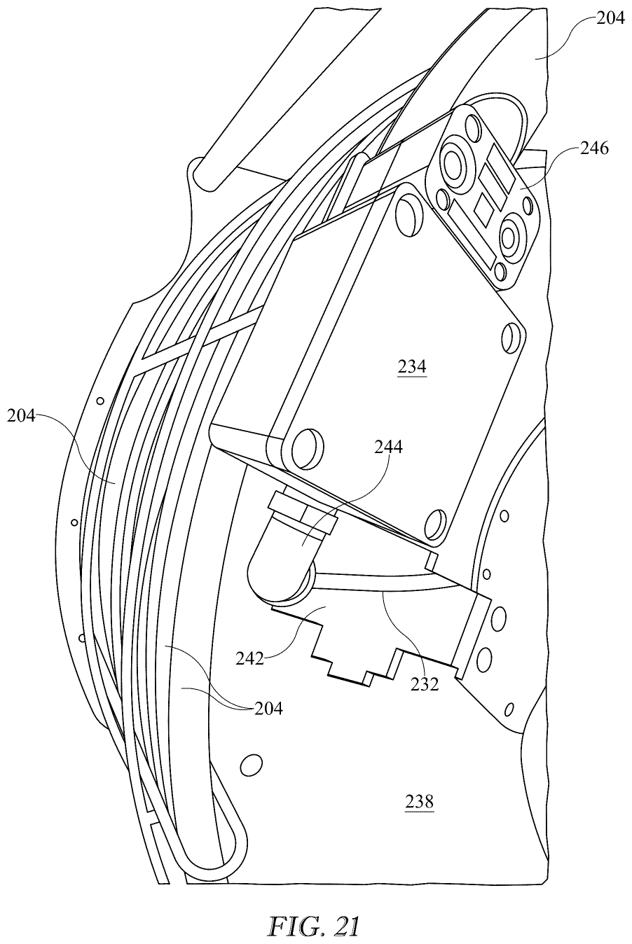

As seen in FIGS. 19 and 20, a plate 238 constitutes part of the rotor component 230. The four conductors connected to the rotor output of slip ring unit 224 pass through a 90 degree cable gland 240 and into a short cable/hose section 232. As seen in FIGS. 20 and 21, the hose section 232 is passed through a hole 242 in the plate 238 and terminates, via another 90 degree fitting 244, at an input of connection box 234. The power/air hose 204 is connected to box 234 via a barb fitting 246.

FIG. 2 is a schematic axial section of a completed pipeliner bladder assembly 302, prior to its being pushed into or drawn into the pipe P. In general, the components of assembly 302 are arranged on a longitudinal axis X, which in use will also be the pipe axis. Relative to assembly 302, “proximal” and “distal” are axial directions opposed to each other, with “proximal” being toward the air hose 204 and “distal” in the direction of the pull eye 404. “Radial” connotes a direction at right angles to axis X.

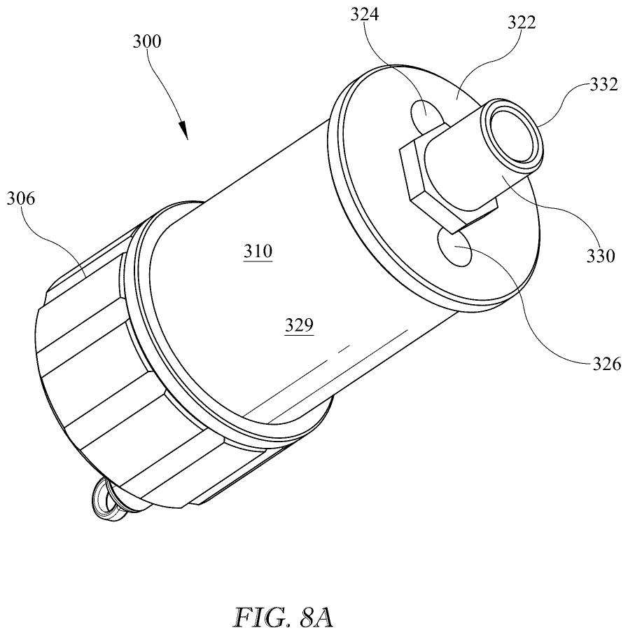

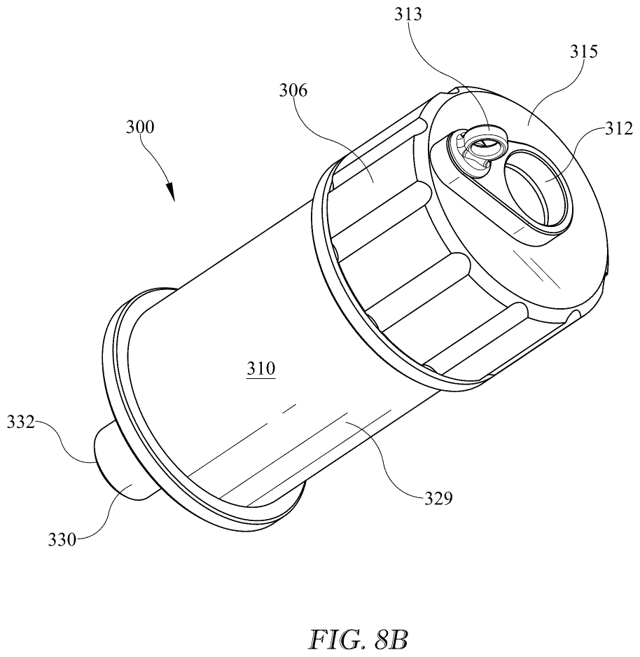

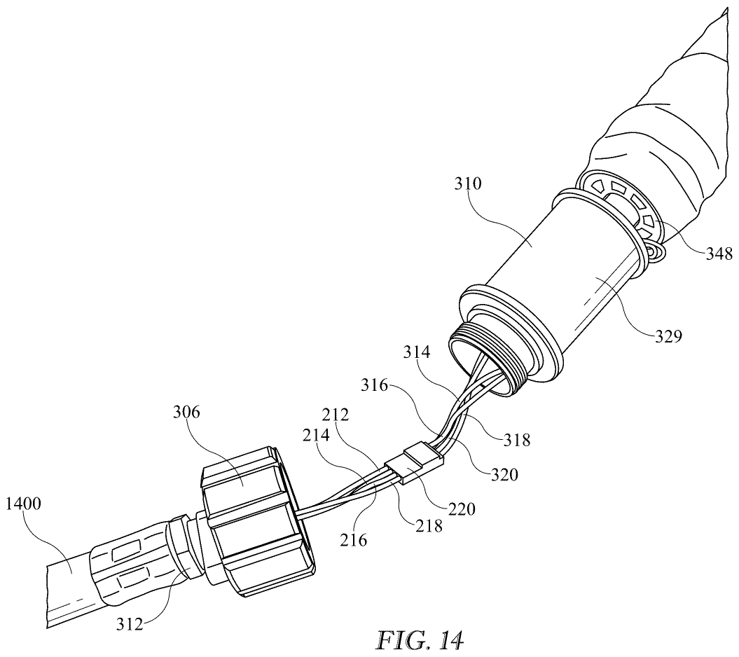

The air head 300, details of which may also be seen in FIGS. 8A and 8B, has a cap 306 that may be screw-threaded onto a proximal end 308 of a hollow head body 310. The cap 306 may have a central input port 312 formed on its axis, which port 312 is threaded and which accepts a threaded distal end 210 of the supply hose 204. Alternatively, and as will be described below, the central input port 312 may be threadedly connected to a terminal hose section 1400 (FIGS. 14 and 15) provided for this purpose and which in turn is threaded to supply hose 204. The threaded end 210 may be a part of a brass hex fitting, for example.

Supply hoses 104 and 204 and their connections should be able to withstand internal pressures of at least 60 psi, and should also be rigid enough to withstand a modest partial vacuum, such as 15 atm.

FIGS. 14 and 15 illustrate an embodiment in which the supply hose 204 is connected to a short heavy duty hydraulic hose lead 1400, which in turn is hermetically connected to central input port 312 of the air head 300. The hose section 1400 is finished with a tough cloth and can withstand more repeated bending and rubbing than supply hose 204. The hose section 1400 is capable of withstanding the same positive and negative air pressures as hoses 104 and 204. The four conductors 212-218 will be threaded through section 1400 to connector 220.

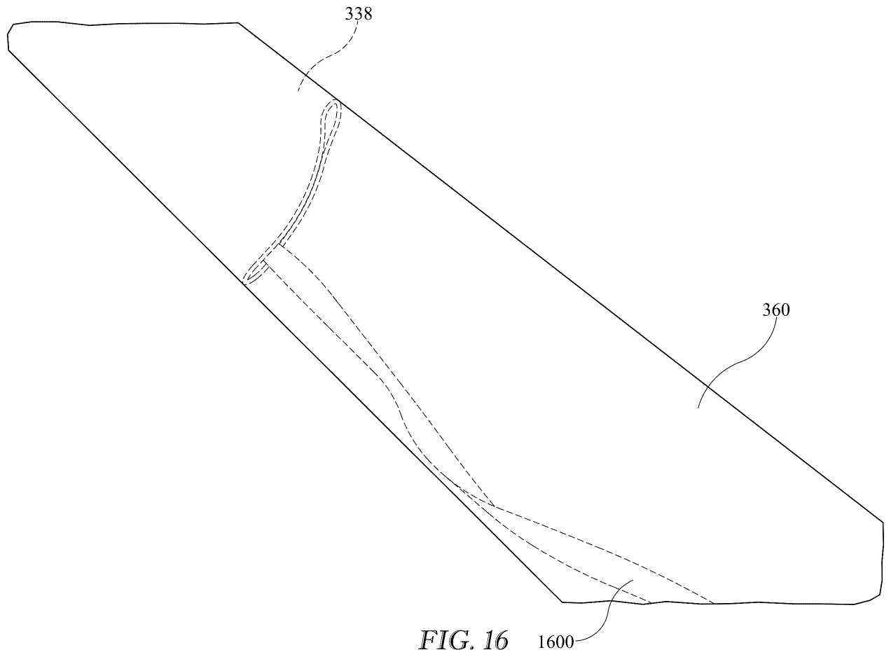

As seen in FIG. 8B, cap 306 may have an eye 313 on its proximal face 315 which may be used in pulling the bladder 328 and the carrier through the liner 338, after the liner 338 is wetted out with resin. A flat rope 1600 for this purpose is shown in FIG. 16. The rope 1600 extends all of the way through liner 338 and is interior to the sacrificial packer liner 360; the rope 1600 then may be connected to the eye 313 to pull the air head 300, push rod 334 and light carrier 348 through the liner 338 so as to create the liner assembly 302. The eye 313 may also be used in maneuvering the bladder assembly inside the pipe P, as by withdrawing the bladder 328 and carrier 348 once the curing of the resin has been completed and the bladder 328 deflated. The eye 313 may be formed as a separate screw-threaded component and screwed into place inside of an eye bolt hole 317 provided for this purpose.

Returning to FIG. 2, a plurality of insulated conductors, including an LED power conductor 212, an LED return or ground 214, a temperature probe power conductor 216, and a temperature probe return conductor 218 originate at connector 236 in connection box 234 and are threaded through the interior of supply hose 204. The distal ends of conductors 212-218 are plugged into an electrical connector 220 housed in a chamber 313 defined by air head body 310 and cap 306. The cap 306 may be unscrewed in order to make this connection. Proximal ends of air bladder assembly conductors 314, 316, 318 and 320, which respectively correspond to and are electrically connected to conductors 212, 214, 216 and 218, are likewise plugged into electrical connector 220.

A distal end 322 of the air head 300 has at least one, and preferably two, air ports 324 and 326, through which pressurized air flows into a bladder 328 that is hermetically sealed to an external cylindrical wall or surface 329 of the air head body 310, and into which air is later withdrawn by application of partial vacuum. LED power conductors 314 and 316 may be routed through first air port 324, while temperature probe conductors 318 and 320 may be routed through second air port 326. The distal end 322 of air head 300 may further be equipped with a reinforcing or push rod receptacle 330, which may be internally threaded or otherwise crimped to receive a proximal end 331 of a reinforcing rod 334. A distal end 332 of the receptacle 330 may also serve as an abutting standoff of a proximal light carrier end 336, to which, in the illustrated embodiment, the air head 300 intentionally is not directly affixed.

In the illustrated embodiment, the bladder 328 is firmly affixed and sealed to the air head cylindrical surface 329 by way of a layer of tape 338 and two circumferential clamps 341 and 343.

Bladder 328 is dimensionally stable in both axial and circumferential directions. It does not stretch much or at all when significant tensile force is placed on it, as by pull head 400. The woven material of bladder 328 is also very tough. The material, available for example from Bodenbender GmbH of Breidenstein, Germany, is a one piece woven (OPW) polyester/nylon tube that may about 7 mm thick, Bladder 328 is silicone-coated on its exterior and can withstand thermal loads of at least 150 C. This makes bladder 328 a complete substitute for the pull ropes typically found in prior art bladder assemblies, which pull ropes run the entire length of the bladder assembly and complicate their design. Prior art bladder assemblies needed these retention straps or ropes to prevent the axial expansion or growth of the bladder, which conventionally is made of an elastomer.

As initially installed in the pipe, the bladder 328 will be slack. Upon a predetermined amount of internal fluid pressure, bladder 328 will inflate in a radial or circumferential direction, at right angles to the axial direction, to a predetermined limit, beyond which it will not expand further. The size as inflated of bladder 328 is chosen according to the diameter of the pipe to be repaired and the thickness of the liner 338 radially exterior to it. Bladder 328's radial or circumferential stability is also useful in that the liner 338 disposed to the radial exterior of the bladder 328 will only get pushed out so far, and under pressure will not develop “hernias” inside the pipe or invade large open spaces, including large open voids in the pipe that the liner is attempting to seal back up and repair.

In the embodiment illustrated in FIG. 2, the LED power conductor 314 and the LED ground 316 are branched at nodes 340 and 342, respectively. An internal LED power conductor 344 passes through a lumen 346 in the light carrier 348. Likewise, an internal LED ground conductor 350 is threaded through lumen 346. An external LED power conductor 351 connects node 340 to a proximal power input of an LED light string 352, while an external LED ground conductor 354 connects node 342 to a proximal ground connection of LED light string 352. Temperature probe conductors 318 and 320 may be threaded through a second lumen 356 of the light carrier 348.

Reinforcing or push rod 334 may be fabricated of Standard E fiberglass. It may have a strength in the range of 20-30 Gigapascals or 2,900-4,350 ksi (kilopounds per square inch). Reinforcing or push rod 334 may be epoxy impregnated fiberglass with a plastic outer jacket.

The main purpose of reinforcing rod 334 is to lend some rigidity to the light carrier 348, which may be extruded from a relatively yieldable material such as silicone rubber. This aids in pushing the bladder assembly into pipe P, in those situations where the location of repair is not far from the pipe entrance and is not long. Rod 334 may experience small amounts of compressive or tensile force when pushing or pulling assembly 302 through pipe P, but the assembly primarily relies on the strength of woven bladder 328 for axial retention strength. For example, when assembly 302 is being pulled around a 90 degree bend in pipe P, more than normal force will be exerted on rod 334, but the assembly still relies on bladder 328 for axial strength.

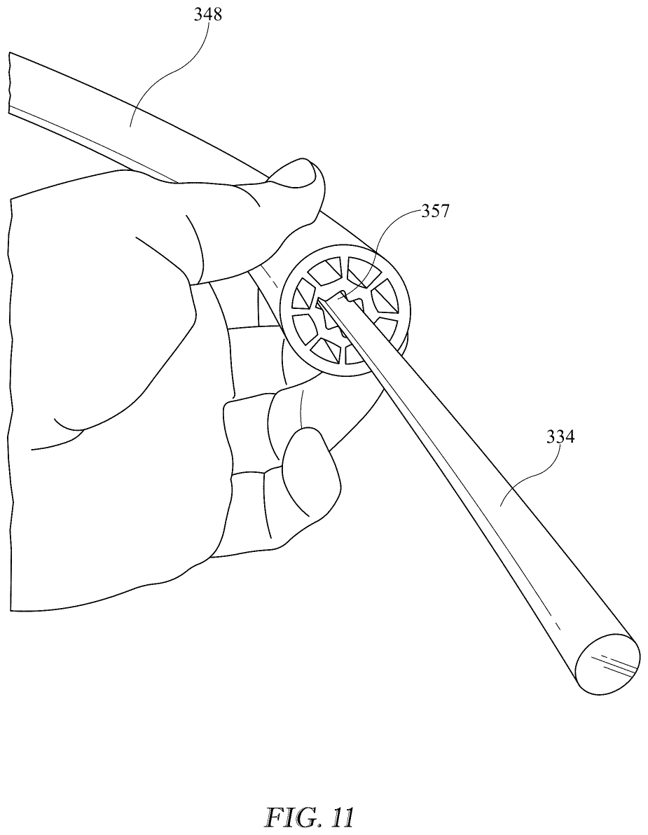

The reinforcing rod 334 may be loosely passed through a central lumen 357 of the light carrier 348, as is seen in FIGS. 4 and 11. This means that the light carrier 348 and the structures it supports will “float” with respect to any tensile or end-compressive force placed on the bladder assembly 302, avoiding structural damage to, separation of or electrical disconnection of those structures.

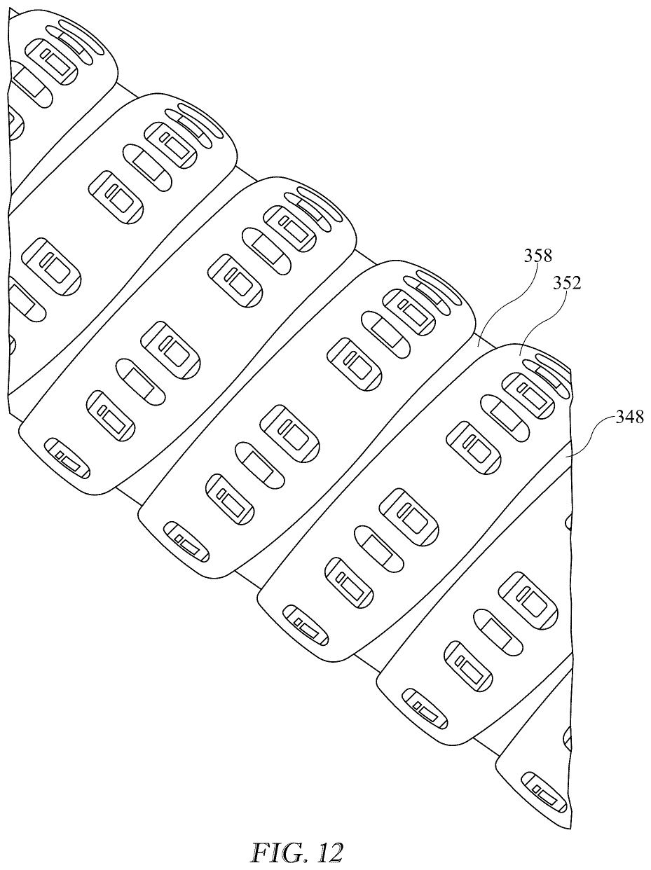

The radiation source used to cure the resin in the liner 338 may be an LED light string 352 helically wound on the outer cylindrical surface 358 of the light carrier or light bar 348. The LED light string may be one of at least two kinds: a string of ultraviolet (UV) LEDs, or a string of infrared (IR) LEDs, chosen by the user according to the nature of the resin that is to be cured. Two such light strings 352 are available from Zirqle and are sold under the trademark LUXALIGHT®. One such light string 352 is shown in FIG. 12.

The liner 338 is disposed radially exteriorly of the bladder 328. Prior to its insertion into pipe P, the liner 338 will be jacketed with a sacrificial plastic packer liner 360, seen also in FIG. 16. Packer liner 360 is used to contain the uncured resin as the material making up liner 338 is wetted out. Before the assembly 302 is pulled into pipe P, the plastic packer liner 360 is removed.

The system according to the invention may be used either with UV-curable or IR-curable liners. Liner 338 may comprise a fiber glass liner with UV-curable resin, which the inventors have found has a much better and faster refraction rate than the woven polyester and felt liners used in prior art devices. In this instance, light string 352 will consist of or comprise UV-emitting LEDs. For example, LEDs may be chosen that emit ultraviolet radiation in a 395-405 nm band. Alternatively, the light string may be specified as being composed of or comprising infrared LEDs. In this last instance, the liner 338 will be impregnated with a 2-part epoxy resin (base and hardener).

The distal end 303 of the bladder assembly 302 is shown in more detail in FIG. 3. To complete the seal of the bladder 328, bladder 328 is firmly clamped to an outer cylindrical surface 406 of the pull head 400 as with the aid of tape 408 and circumferential clamps 410 and 412. The pull eye 404 may be screwed into threaded receptacle 414 opening on the distal end 416 of the pull head 400.

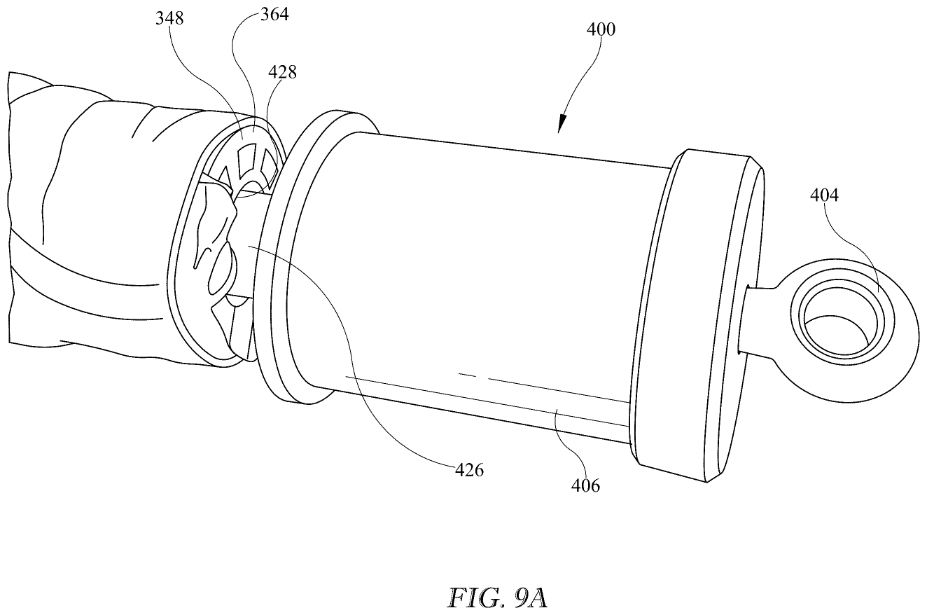

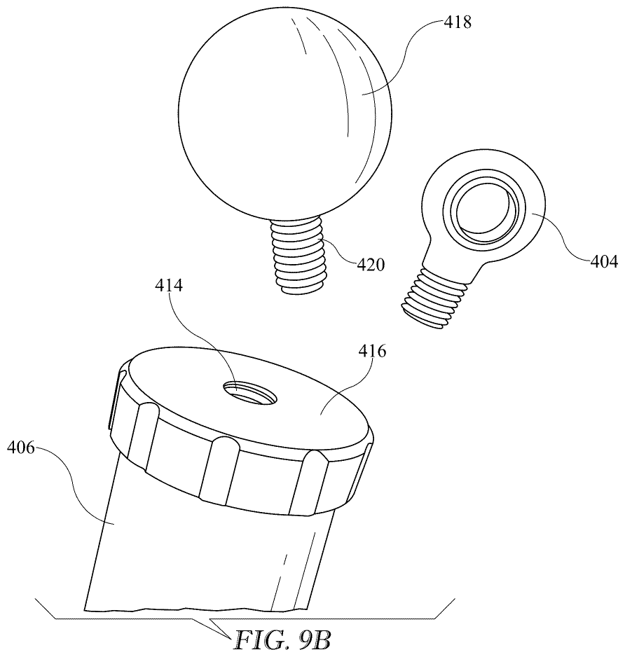

As seen in FIG. 9B, the pull eye 404 may be unscrewed from receptacle 414 and replaced with a sphere 418. Sphere 418 has a threaded shaft 420 for this purpose. In situations in which the bladder assembly 302 is pushed into the pipe P instead of pulled, sphere 418 may be used to better negotiate the pipe path. Other shapes could be used, such as one that had a largest radius equivalent to or larger than a radius of cylindrical pull head surface 406, and a paraboloidal or bullet shape could be substituted. Air head 300 and pull head 400 may be machined out of stainless steel.

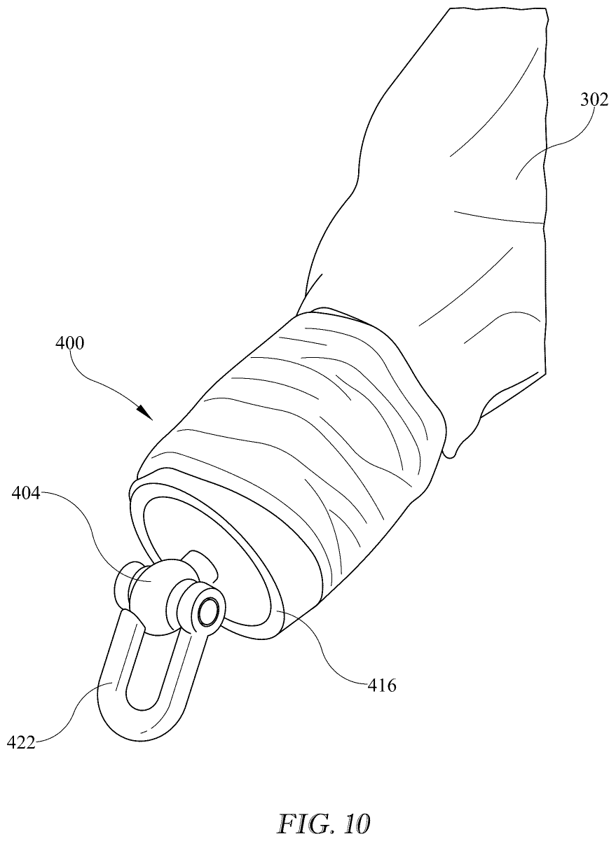

The pull rope 402 may be looped directly through eye 404, or, as shown in FIG. 10, a link 422 may be inserted therethrough and the pull rope 402 looped through that. Link 422 adds flexibility and ease of assembly.

Returning to FIG. 3, a proximal end 424 of the pull head 400 is furnished with a push rod receptacle 426 that may extend proximally therefrom. A distal end 362 of the push or reinforcing rod 334 is threaded, crimped or otherwise affixed into the receptacle 426. A proximal end 428 of the push rod receptacle 426 also serves as an abutting standoff to a distal end 364 of light carrier or light bar 348. In the illustrated embodiment, the light carrier 348 is not directly connected to pull head 400 and will not experience any tensile force communicated to it by pull head 400 or any compressive force transmitted by push rod 334; it “floats”.

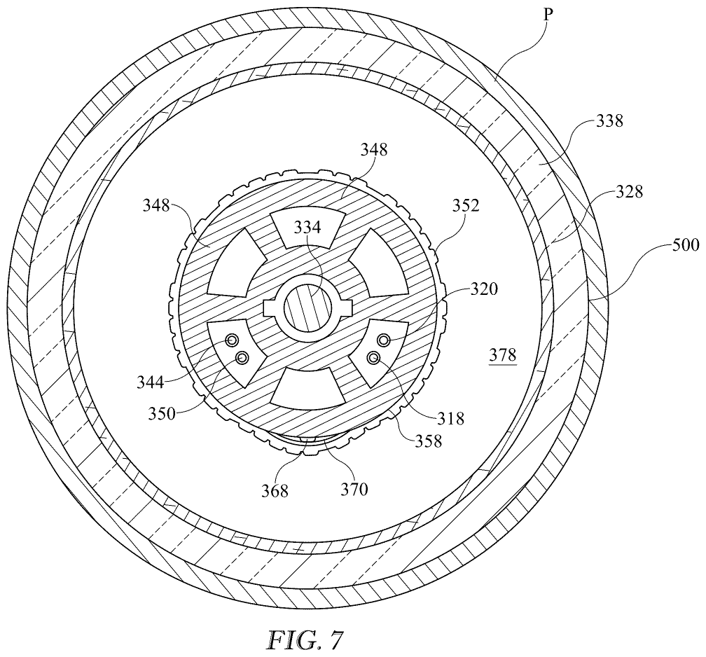

In the illustrated embodiment, the internal LED power conductor 344 and the internal LED ground conductor 350 are threaded through a distal end 366 of the lumen 346, routed around carrier end 364, and connected to respective distal electrical terminals of LED light string 352. The temperature probe conductors 318 and 320 are threaded through an end 368 of lumen 356 and then passed around distal carrier end 364 to light carrier cylindrical exterior surface 358. They are then routed proximally, along surface 358, to approximately midway on the light carrier length, at which point they are connected to a temperature probe 368 as is seen in FIGS. 4 and 7. The probe 368 may be taped to external surface 358 with tape 370. Alternatively a suitable receptacle may be made in external surface 358 to house the probe 368. In the illustrated embodiment, the LED light string 352 is wound on top of the portion of probe conductors 318 and 320 that lay on external surface 358, and is wound on top of or radially exteriorly to the probe 368 and tape 370.

In some instances, the diameter of light carrier 348 may be too small to accommodate the LED power conductors or the temperature probe conductors. Such an embodiment is shown in FIG. 13. In this instance, the proximal end LED power conductors 351 and 354 are connected to proximal terminals of the LED light string 352, as before. But the distal end LED power conductors 344, 350 will be laid on external cylindrical carrier surface 358, as will the temperature probe conductors 318 and 320, and the LED light string 352 will be helically wound on top of them.

FIG. 4 is a very schematic cross-sectional view taken about midway along bladder assembly 302, at the location where temperature probe 368 is installed. In other embodiments, a number of axially or angularly spaced-part temperature probes could be provided, with sets of dedicated conductors for each. The bladder 328 has not yet been inflated and may take on a wrinkly appearance. Radially surrounding bladder 328 is the liner 338, here highly schematically shown to be cylindrical. In actuality the liner 338 at this point in the process may be a somewhat flat oval and will touch the exterior surface of bladder 328 at many points. At this stage, the liner 338 has been wetted out with a radiation-curable resin. Exterior to the liner 338 is a sacrificial plastic packer liner 360, a sleeve for containing the uncured resin in a liquid or semiliquid state. It is removed (such as being filleted off) prior to pulling the bladder assembly through the pipe P.

The light carrier or light bar 348 may be an extrusion of a suitable polymer such as silicone and is very flexible. As shown, the light carrier 348 has seven lumens in it, with a central lumen 357 surrounded by a circular wall 372. Six radial walls 374 connect circular wall 372 to a cylindrical exterior wall 376, which presents the cylindrical exterior surface 358 upon with the LED light string 352 is helically wound. Extruded light carriers of alternative designs may be used, such as ones with fewer lumens.

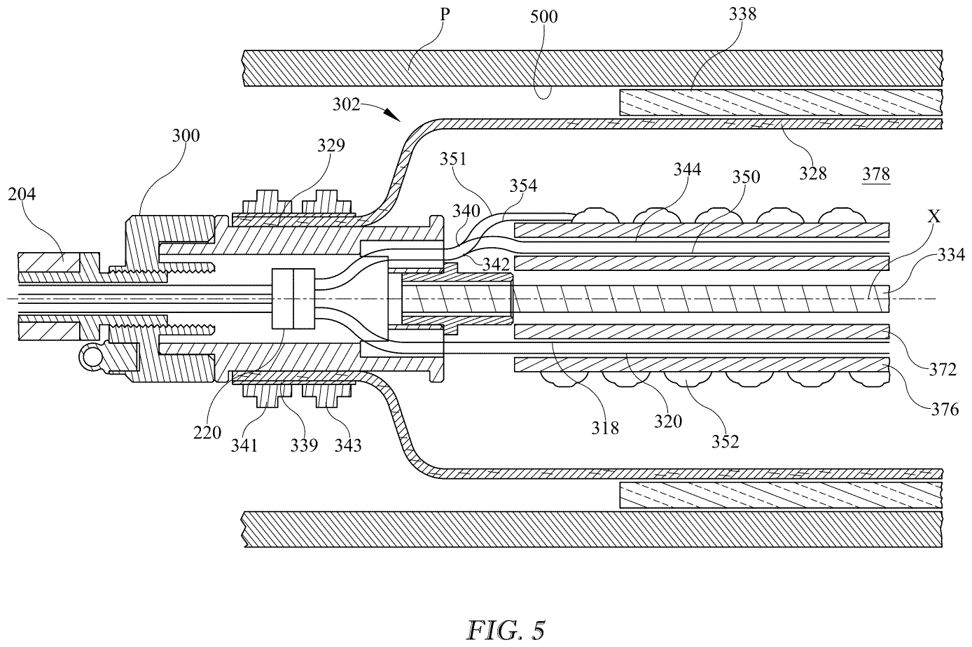

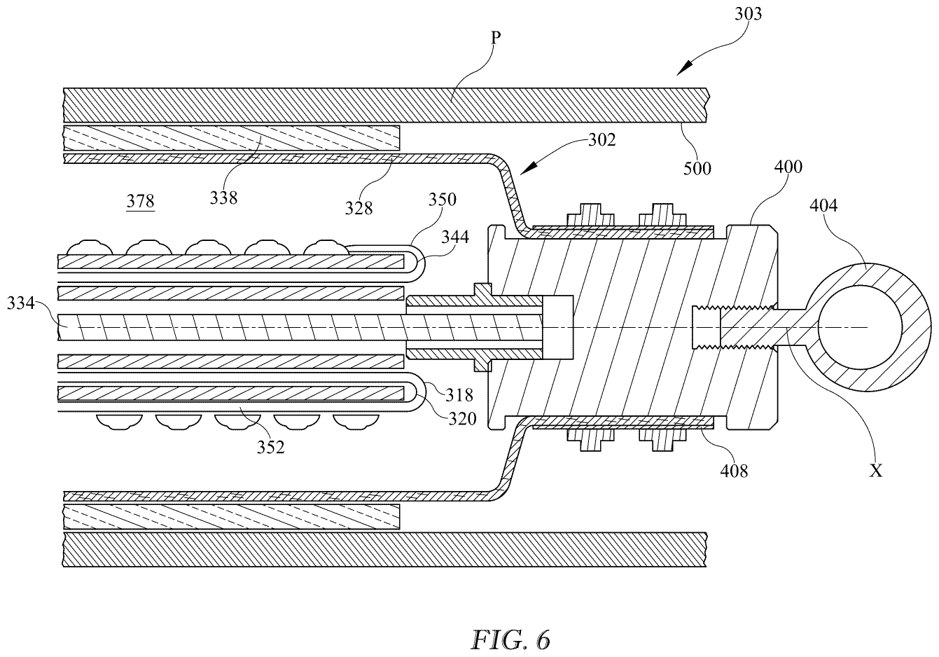

FIGS. 5, 6 and 7 show the pipeliner assembly 302 after it has been pushed or pulled into the desired location inside of pipe P. Line 204 has supplied a pressurized gas, such as air, to the interior 378 of bladder 328. In response, the bladder 328 inflates, pushing the impregnated liner 338 up against an internal surface 500 of the pipe P—and also sealing cracks and voids in pipe P. The inflation pressure may be as much as 50 to 60 psi, far greater than the pressures used in conventional pipeliner bladder assemblies. For a particular size of pipe, a particular maximum radius of bladder 328 may be chosen to be somewhat or a little larger than the internal pipe diameter. This ensures that cracks and voids will be smoothly bounded by the liner 338 after curing and that the liner 338 will not substantially bulge out into voids in the ground surrounding the repair location.

Once the bladder 328 is pressurized, power is switched on to LED power conductors 351 and 344, causing the LED light string 352 to illuminate. The curing of the resin inside of liner 338 is exothermic, and for this reason, the temperature as reported by the temperature probe 368 may be monitored to judge the progress of the cure.

After curing, bladder 328 is deflated by introducing a partial vacuum into supply hose 204. The bladder 328 and also components interior to it may then be withdrawn from pipe P, concluding its successful repair.

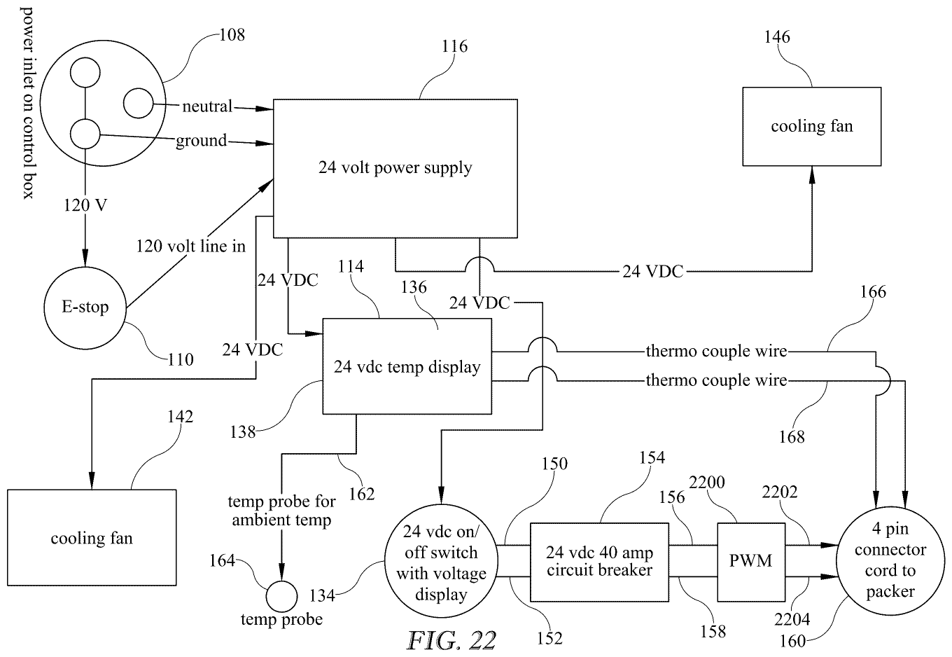

FIG. 22 is an electrical schematic diagram of a system according to the invention that includes a pulse width modulator (PWM) 2200. Line 156 delivers +24V DC to one input of the PWM 2200 while line 158 delivers −24 VDC to another input of the PWM 2200. Line 2202 is connected from an output of PWM 2200 to the 4-pin connector 160 and line 2204 is connected from another output of PWM 2200 to connector 160. Positive 24V pulsed voltage will appear on line 2202 while negative 24V pulsed voltage will appear on line 2204. The frequency of the output can be chosen as 0.024 KHz at a 95% duty cycle.

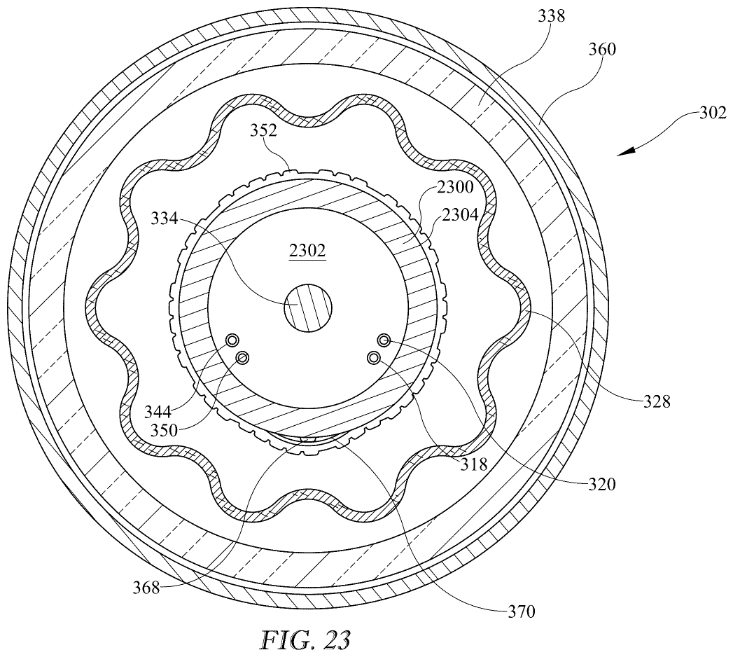

FIG. 23 is a schematic sectional view showing an embodiment in which a braided hose 2300 is substituted for light carrier 348. The hose 2300 has a single lumen 2302 in which is carried reinforcing rod 334, internal LED conductors 344 and 350 and temperature probe conductors 318 and 320. The LED light string 352 is helically wound on the external cylindrical surface 2304 of the hose 2300.

In summary, a novel trenchless pipe repair system and pipeliner bladder assembly have been shown and described. Conductive slip rings in a power cable/hose reel permit the hose to be easily wound and unwound at the location, and further permit the routing, internal to the supply hose, of the necessary conductors for the curing LED light string and temperature probe. The bladder of the system is axially and radially stable, inflatable under high pressure only to a predetermined diameter, and tough enough to accept most or all of the tensile load placed on it as the pipeliner bladder assembly is being pulled through the pipe to be repaired. Nonetheless, the more delicate electronics of the assembly's light carrier or light bar are insulated from potentially destructive tensile or compressive forces placed on the assembly during positioning of the assembly inside of the pipe to be repaired.

While illustrated embodiments of the present invention have been described and illustrated in the appended drawings, the present invention is not limited thereto but only by the scope and spirit of the appended claims.

We claim:

1. A pipeliner bladder assembly comprising:
an elongate light carrier mounting a curing light source;
a pulse width modulator coupled to the curing light source to deliver pulsed power to the curing light source;
a fluid-impervious bladder disposed radially exteriorly of the carrier, the bladder inflating under predetermined fluid pressure; and
a resin-impregnated liner disposed radially exterior to the bladder, the resin being curable by the light source.

2. The pipeliner bladder assembly of claim 1, wherein the pulse width modulator delivers power to the curing light source at 24V, 0.024 KHz, and a 95% duty cycle.

3. The pipeliner bladder assembly of claim 1, wherein the light carrier has a cylindrical outer surface, the curing light source comprising a strip of LEDs wound helically on the outer surface of the light carrier.

4. The pipeliner bladder assembly of claim 1, wherein the LEDs are either ultraviolet emitting diodes or infrared-emitting diodes.

5. The pipeliner bladder assembly of claim 1, wherein the assembly is disposed on an axis, the light carrier having a distal end, the assembly further comprising a pull head disposed distally from the distal end of the light carrier, the bladder being firmly affixed and sealed to the pull head.

6. The pipeliner bladder assembly of claim 1, wherein the assembly is disposed on an axis, the light carrier having a proximal end, the assembly further comprising an air head physically uncoupled from the light carrier, an air port of the air head in fluid communication with an interior of the bladder, the light carrier having a first lumen opening on the proximal end of the light carrier, an elongate flexible push rod loosely received in the first lumen; wherein
the push rod has a proximal end, the first end of the push rod being affixed to the air head.

7. A system for the trenchless repair of a pipe, the system comprising:
a pipeliner bladder assembly disposed on an axis and adaptable to be pulled or pushed into a pipe to be repaired, the assembly including:
an elongate light carrier disposed on the axis, the light carrier having an external surface radially displaced from the axis, a plurality of resin-curing radiation sources mounted on the external surface of the light carrier;
the light carrier being hollow, having opposed first and second axial ends, and at least one lumen communicating the first axial end with the second axial end;
an air head disposed on the axis at the first end of the light carrier and having at least one air port;
an elongate gas-impervious bladder disposed radially around the light carrier, a first end of the bladder being sealably affixed to the air head, the air port of the air head being in fluid communication with an interior of the bladder;
an elongate liner disposed radially exteriorly of the bladder and being impregnated with a radiation-curable resin;
a controller, a power supply of the controller coupled to a pulse width modulator, outputs of the pulse width modulator coupled to output power conductors to deliver pulsed power to the output power conductors;
a pressurized air source connected to a first end of a pressurized air conduit, the controller operable to regulate an air pressure inside of the air conduit;
the output power conductors disposed in an interior of the air conduit, a second end of the air conduit coupled to an inlet of the air head, a chamber of the air head connecting the inlet of the air head to at least one air port, the output power conductors terminating in a connector disposed in the chamber, second power conductors having first ends connected to the connector, the second power conductors routed through the at least one air port of the air head to the at least one lumen of the carrier and coupled to the resin-curing radiation sources to provide power thereto, pressurized air supplied through the at least one air port of the air head to inflate the bladder.

8. The system of claim 7, wherein the pulsed power output from the pulsed width modulator is at 0.024 KHz with a 95% duty cycle.
